(19) United States
(12) Patent Application Publication
(10) Pub. No.: US 2012/0223639 A1
(43) Pub. Date: Sep. 6, 2012

(54) METHOD FOR MANUFACTURING A CONDUCTIVE CONNECTION OF A METALLIC ELECTRODE WIRE AND A METALLIC LEAD-IN WIRE

(75) Inventors: Kirsten Gerta Baeumges, Viersen (DE); Reiner Feder, Simmerath (DE)

(73) Assignee: KONINKLIJKE PHILIPS ELECTRONICS N.V., EINDHOVEN (NL)

(21) Appl. No.: 13/509,866

(22) PCT Filed: Sep. 29, 2010
(86) PCT No.: PCT/IB10/54377

§ 371 Date: May 15, 2012

(30) Foreign Application Priority Data
Nov. 17, 2009 (EP) 09176246.8

(51) Int. Cl. H01J 61/36; H01J 9/36; H01J 9/28

(52) U.S. Cl. 313/623; 445/29; 445/69

(57) ABSTRACT

This invention describes a method for manufacturing a conductive connection of a metallic electrode wire (1) and a metallic lead-in wire (3) for a gas discharge lamp (11), preferably a ceramic discharge metal halide lamp. The method includes a bending step, whereby an end portion (4) of the lead-in wire (3) is bended and folded over such that a first section (15) of the end portion (4) at the tip of the lead-in wire (3) overlaps a second section (16) of the end portion (4). Furthermore, the method includes the placement of the electrode wire (1) in-between the first section (15) and the second section (16) of the folded-over end portion (4) of the lead-in wire (3). Finally, a connection is formed between the electrode wire (1) and the lead-in wire (3) by stamping at least parts of the folded-over end portion (4) of the lead-in wire (3) while heating at least a part of the lead-in wire (3) such that the first section (15) and the second section (16) of the folded-over end portion (4) are at least partially touching a portion of the electrode wire (1). Furthermore, the invention describes a gas discharge lamp (11), comprising a conductive connection of a metallic electrode wire (1) and a metallic lead- in wire (3) and a corresponding manufacturing system (50).

### FIELD OF THE INVENTION

This invention relates to a method for manufacturing a conductive connection of a metallic electrode wire and a metallic lead-in wire for a gas discharge lamp. Furthermore, the invention relates to a gas discharge lamp, in particular a ceramic discharge metal halide (CDM) lamp, comprising a conductive connection of a metallic electrode wire and a metallic lead-in wire as well as a corresponding manufacturing system.

### BACKGROUND OF THE INVENTION

Gas discharge lamps, for example mercury vapor discharge lamps, comprise an arc tube which consists of material capable of withstanding high temperatures, for example quartz glass or a translucent ceramic material. The arc tube encloses a discharge chamber. From opposite sides, electrode wires, typically made of a refractory metal, protrude into this discharge chamber which contains a filling consisting of one or more rare gases, and, in the case of a mercury vapor discharge lamp, mainly of mercury. By applying a high ignition voltage across the tips of the electrode wires inside the discharge chamber, a plasma arc is generated between the tips, providing the desired light emission. To connect the electrode wires of the arc tube electrically to the outside of the gas discharge lamp, the electrode wires are often connected to so-called lead-in wires. Besides the electrical connection, the lead-in wires might also provide a mechanical support for the arc tube, sometimes configured such that the lead-in wires provide an additional strain-relief and also a thermal or mechanical decoupling for the arc tube and its electrode wires.

During normal lamp operation, the arc tube reaches temperatures of up to 1900° C. or higher. Consequently, the electrode wires and the electrical connection of the electrode wires to the lead-in wires must be able to withstand high temperatures and large temperature swings over the operating life-time of the gas discharge lamp. Therefore, even the lead-in wires are often realized with refractory metals or alloys containing one or more refractory metals.

During the manufacturing process for gas discharge lamps, the electrode wires and the lead-in wires are joined to provide an electrical connection. A common technique to achieve such a connection is resistance welding. Here, an electric current is applied to the wires which heats the wires at least in the regions of higher resistance above the melting temperature of the wire material with the lower melting temperature. The molten material of this wire then forms the connection by embedding parts of the other wire. A drawback of this technique is caused by the high temperature that occurs during the resistance welding, as it is causing a recrystallisation of the wire materials.

Such a recrystallisation, even if it only occurs partially or locally, makes the wire material more brittle. Thereby, its mechanical flexibility, i.e. its bending and tensile strength, is reduced which leads to a higher risk of a failure of the gas discharge lamp during its normal operating life, in particular during vibrations, or even already during the final manufacturing steps. Hence, such a welding technique is disadvantageously limiting the manufacturing yield and operational reliability of the lamp.

Furthermore, the resistance welding technique is normally executed in a so-called butt-welding setup, whereby the electrode wire and the lead-in wire are aligned along their main axis while touching each other at their tips. The relatively high contact resistance at the point where the tips are touching leads to the desired melting of at least one wire which then forms the connection. However, the axial alignment of the wires requires a precise positioning of the wires during the manufacturing process. Often a stringent positioning accuracy of less than 0.1 mm is required. Additionally, the axial setup does not allow any alignment of the relative position of the electrode and the lead-in wire during the manufacturing process, as the tips of the wires have to touch each other exactly to enable the resistance welding. Obviously, those limitations increase the manufacturing costs of a gas discharge lamp.

Therefore, it is an object of the present invention to provide a method for manufacturing a conductive connection of a metallic electrode wire, in particular a metallic refractory electrode wire, and a metallic lead-in wire, in particular a metallic refractory lead in wire of a gas discharge lamp which can be implemented in a simple and inexpensive manner and which obviates the above-mentioned yield and reliability limitations.

### SUMMARY OF THE INVENTION

The invention describes a method for manufacturing a conductive connection of a metallic electrode wire and a metallic lead-in wire for a gas discharge lamp, preferably a ceramic discharge metal halide lamp. The method includes a bending step, whereby an end portion of the lead-in wire is bended and folded over, such that a first section of the end portion at the tip of the lead-in wire overlaps a second section of the end portion, for example by enclosing an acute angle between the two sections or by describing a U-turn like fold. Furthermore, the method includes the placement of the electrode wire in-between the first section and the second section of the folded-over end portion of the lead-in wire. This placement can occur substantially at the same time as the bending step or independently from the bending step. Finally, a connection is formed between the electrode wire and the lead-in wire by stamping at least parts of the folded-over end portion of the lead-in wire while heating—preferably above the brittle-ductile transition temperature—at least a part of the lead-in wire such that the first section and the second section of the folded-over end portion are at least partially touching a portion of the electrode wire.

The heating of the lead-in wire during the stamping step advantageously maintains the ductility of the lead-in wire's material. Thereby, undesired material changes, like cracking, breaking, or splicing, that would negatively impact the material's mechanical flexibility and reliability, are avoided.

Because, according to the invention, the connection between the lead-in wire and the electrode wire is created while heating the lead-in wire but not by melting the lead-in wire, it is possible to control the heating of the lead-in wire so that the electrode wire do not exceed a given temperature limit. Thereby, the heating of the lead-in wire is preferably controlled such that the temperature of the lead-in wire and the electrode wire do not exceed a temperature limit which would lead to an unfavorable recrystallisation of the involved metallic wire materials. Obviously, this temperature limit largely depends on the material properties of the electrode wire and lead-in wire, which are determined e.g. by the grade of thermal pre-processing or the ratio of metallic components of the metallic alloy. For example, for a tungsten-rhenium alloy, a recrystallisation temperature of around 1600° C. is known. Therefore, the heating of the lead-in wire during the stamping step preferably will be controlled such that the temperature does not exceed that limit. Also, to reduce the risk of a partial recrystallisation, a margin of safety may be applied, i.e. the actual temperature of the lead-in wire is kept significantly below the recrystallisation temperature. Furthermore, since the electrode wire and the lead-in wire may be manufactured with different materials and processes, the recrystallisation temperature of the two wires might differ. Hence, the heating of the lead-in wire particularly preferably might be controlled such that neither the lead-in wire nor the electrode wire assume a temperature which would bear the risk of an unfavorable recrystallisation.

In summary, the described heating of the lead-in wire is controlled such that on one hand the temperature is high enough to ensure a sufficient ductility during the stamping while on the other hand is kept low enough to avoid any undesired recrystallisation in any of the involved metallic materials.

Compared to the resistance welding, the invention furthermore advantageously enables corrections in the relative alignment of the electrode wire vs. the lead-in wire, even after the stamping of the folded-over end portion. Therefore, time-consuming and expensive alignment steps can be avoided during the manufacturing process.

A corresponding gas discharge lamp, preferably a ceramic discharge metal halide lamp, comprises at least one electrically conductive connection of a metallic electrode wire and a metallic lead-in wire for which the lead-in wire comprises a folded-over end portion comprising a first section and a second section which are facing each other in a substantially parallel alignment. Furthermore, the electrode wire is arranged in-between the first section and the second section of the folded-over end portion of the lead-in wire such that the first section and the second section are at least partially touching a portion of the electrode wire.

The invention also describes a corresponding manufacturing system for gas discharge lamps, preferably ceramic discharge metal halide lamps, which comprises beyond other units or components related to lamp manufacturing a bending unit for bending an end portion of a metallic lead-in wire which bends and folds over the end portion such that a first section of the end portion at the tip of the lead-in wire overlaps a second section of the end portion. In addition, the manufacturing system comprises a positioning unit for placing a metallic electrode wire of an arc tube in-between the first section and the second section of the folded-over end portion of the lead-in wire. Moreover, the manufacturing system comprises a stamping unit for forming a connection between the electrode wire and the lead-in wire by stamping at least parts of the folded-over end portion of the lead-in wire while heating at least a part of the lead-in wire such that the first section and the second section of the folded-over end portion are at least partially touching a portion of the electrode wire.

The dependent claims and the subsequent description disclose particularly advantageous embodiments and features of the invention.

Preferably, the electrode wire comprises a refractory metal or an alloy comprising at least one refractory metal, like tungsten or molybdenum or an alloy comprising tungsten, molybdenum, or rhenium. In particular, a tungsten-rhenium (WRe) alloy might be used as an electrode material. Similarly, the lead-in wire comprises a refractory metal or an alloy comprising at least one refractory metal, preferably tungsten, molybdenum, tantalum, or niobium or an alloy comprising tungsten, molybdenum, tantalum, or niobium. In a preferred embodiment of the invention, a WRe alloy is used for the electrode wire, while the lead-in wire comprises molybdenum.

Furthermore, in a favorable embodiment, the electrode wire has a substantially circular cross section with a diameter of at least 0.1 mm and at most 0.4 mm, preferably a diameter of around 0.25 mm, while the lead-in wire has a substantially circular cross section with a diameter of at least 0.2 mm and at most 0.5 mm, preferably a diameter of around 0.35 mm. Based on those materials and geometries, the heating of the lead-in wire is preferably controlled such that the lead-in wire assumes a temperature in the range of 200° C. to 300° C., more preferably a temperature of around 250° C., to avoid any recrystallization while still enabling sufficient ductility of the lead-in wire during the stamping step.

In a preferred embodiment of the invention, the stamping of the folded-over end portion is implemented such that parts of the folded-over end portion of the lead-in wire and the imbedded portion of the electrode wire are deformed during the stamping. This deformation leads to a substantially positive locking of the electrode wire and the lead-in wire. The deformation can be achieved by appropriately selecting the pressure that is applied towards the end portion during the stamping step and by appropriately adjusting the heating of the lead-in wire. In addition to a good electrical connection, such a deformation beneficially provides a mechanical support for the electrode wire.

To implement the stamping of the end portion of the lead-in wire, stamp dies, which provide the mechanical pressure to the end portion, might be utilized. Preferably, the heating of the lead-in wire can be achieved by heating at least one, preferably both, of the stamp dies previous to or during the stamping. The heating of the stamp die might be achieved in several ways. A preferred solution would be to arrange one or more dedicated heating elements, preferably heating cartridges, next to the stamp die. The stamp die itself might be heated to a temperature higher than the upper temperature limit for the lead-in wire, as some heat loss will occur and as it would take some time during the stamping until the lead-in wire has assumed the same temperature as the stamp die. For example, a stamp die may be heated up to 300° C., which is still ensuring that the temperature of the lead-in wire stays below the above-mentioned 250° C. Also, a control unit and a temperature sensor may be used in addition to control the temperature of the stamp dies.

In a preferred embodiment of the invention, the first section and the second section of the end portion of the lead-in wire are aligned substantially in parallel. This parallel alignment might be achieved either during the bending of the end portion or during the stamping which forms the connection. In particular, at least one of the mentioned stamp dies might be configured such that the stamping step leads to a parallel alignment.

In a favorable embodiment of the invention, a planar contact area is formed by flattening the end portion of the lead-in wire previous to the bending of the lead-in wire. For example, the above-described lead-in wire having a diameter of 0.35 mm might be reduced in thickness to around 0.24 mm. A planar area is advantageous as it increases the contact area between the electrode wire and the lead-in wire, thus providing an improved electrical connection and a better mechanical support of the electrode wire. In a particularly preferred embodiment, flattening dies are applied to form the planar contact area and at least one, preferably both, of the flattening dies is heated to heat the lead-in wire during the flattening. Similar to the heating of the lead-in wire during the stamping, the ductility of the lead-in wire is thereby maintained during the flattening, which is reducing the risk of undesirable failures.

In preferred embodiment, the method according to the invention might comprise an alignment step of the position of the electrode wire relative to the folded-over end portion of the lead-in wire. Especially, this step can be utilized to align the lead-in wire substantially perpendicular to the electrode wire. Furthermore, the relative position of electrode wire along its main axis can be adjusted. Such an alignment may be executed even after the stamping step.

In a particularly preferred embodiment, an end portion of the electrode wire is heated after forming the connection such that a region of the end portion of the electrode wire is melting. Especially, the melting might be controlled such that the molten region of the end portion of the electrode wire is partially touching the folded-over end portion of the lead-in wire. Thereby, the electrode wire is fixed to the lead-in wire and an improved electrical contact between the electrode and the lead-in wire is achieved. In particular, the molten region of the electrode wire might enclose parts of the end portion of the lead-in wire, thereby acting as a mechanical clamp to the first and second section of the end portion of the lead-in wire. Such a clamp-like structure prevents the fold or acute angle described by the two sections from opening up. Hence, it may beneficially improve the mechanical stability, thereby ensuring a sufficient electrical connection over the life time of the gas discharge lamp. Since the heating and melting of the electrode wire is limited to a smaller end portion, only a very small volume of the electrode wire might be affected by recrystallisation. Consequently, the mechanical flexibility of the overall connection, i.e. its bending and tensile strength, is hardly or not at all impacted. As a result, still a more reliable connection is obtained compared to the known resistance welding methods.

Preferably, a laser beam is employed to heat and melt the end portion of the electrode wire, since laser beams allow a very localized and fast heating of material without affecting the surrounding material or structures. For example, in order to melt the tip of a WRe electrode wire with a diameter of around 0.25 mm, a laser pulse as short as 5 ms with a beam diameter as small as 0.40 mm might be sufficient.

The disclosed method for manufacturing a conductive connection between a metallic electrode wire and a metallic lead-in wire can be applied advantageously to the manufacturing of a gas discharge lamp, preferably a ceramic discharge metal halide lamp. Hereby, an arc tube is provided which comprises a translucent discharge vessel which is enclosing a discharge chamber filled with an ionizable filling. The vessel typically consists of a heat resistant material, for example quartz glass or translucent ceramics. The ionizable filling might contain mercury, argon, or metal halide salts for example. Furthermore, the arc tube includes at least two metallic electrode wires which are partially embedded in the discharge vessel, whereby each electrode wire has a first end that extends into the discharge chamber and a second end that extends to the outside of the discharge vessel. In order to connect the electrode wires to the outside of the gas discharge lamp, lead-in wires are connected to them by the connection method according to the invention. Additionally, an end portion of the electrode wires may be heated, for example by a laser beam, after forming the connection such that a region of the end portion of the electrode wires is melting. Especially, the melting might be controlled such that the molten region of the end portion of the electrode wires is partially touching the folded-over end portion of the lead-in wires. Finally, the arc tube and the lead-in wires are enclosed at least partially in a translucent outer bulb. The electrical connection of the lead-in wires to the outside of the bulb is for example established directly by the lead-in wires. Alternatively, in an preferred embodiment of the invention, additional connections are provided. Such electrical connections might include, but are not limited to, molybdenum foils. Often, the molybdenum foils and parts of the lead-in wire are embedded in the material of the outer bulb, typically by heating and stamping parts of the outer bulb, leading to a tight sealing of the region where the connectors pass through the outer bulb. The described method might be implemented manually or as a mixture of manual, semi-automatic and automatic manufacturing steps. However, it is also within the scope of the invention, that the method is realized in a completely automated fashion.

Other objects and features of the present invention will become apparent from the following detailed descriptions considered in conjunction with the accompanying drawings. It is to be understood, however, that the drawings are designed solely for the purposes of illustration and not as a definition of the limits of the invention.

### BRIEF DESCRIPTION OF THE DRAWINGS

FIG. 1 shows three views of a flattened and folded-over end portion of a metallic lead-in wire enclosing a metallic electrode wire according to an embodiment of the invention;

FIG. 2 shows a cross section view of a stamping unit with two stamp dies and a flattened and folded-over end portion of a metallic lead-in wire enclosing a metallic electrode wire according to an embodiment of the invention;

FIG. 3 shows three views of a flattened and folded-over end portion of a metallic lead-in wire enclosing a metallic electrode wire with a molten end region according to an embodiment of the invention;

FIG. 4 shows a cross section view of a gas discharge lamp according to the invention;

FIG. 5 shows a schematic block diagram of a manufacturing system for gas discharge lamps according to an embodiment of the invention.

### DETAILED DESCRIPTION OF THE DRAWINGS

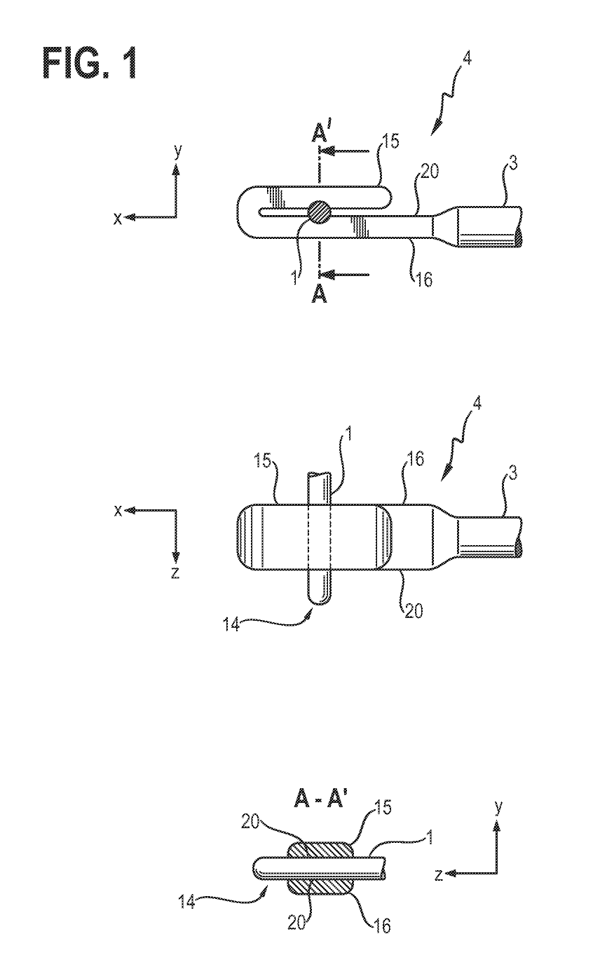

In FIG. 1, three views of a connection with a flattened and folded-over end portion 4 of a metallic lead-in wire 3 enclosing a metallic electrode wire 1 according to the invention are shown. The upper part of FIG. 1 depicts a cross section through the connection along the main axis of the lead-in wire 3. On the right side of the upper part of FIG. 1, the lead-in wire 3 exhibits a substantially circular cross section, while the left part of the lead-in wire 3 is flattened. The upper first section 15 of the end portion 4 of the lead-in wire 3 is aligned substantially in parallel to the lower second section 16 of the end portion 4 of the lead-in wire 3. Furthermore, the first section 15 and the second section 16 of the end portion 4 of the lead-in wire 3 are deformed in the proximity to the electrode wire 1, leading to a tight positive locking of the electrode wire 1. The center part of FIG. 1 illustrates a top view on the connection, while the lower part of FIG. 1 shows another cross section, that demonstrates how the electrode wire 1 is locked in-between the upper and lower section of the planar contact 20. Still, in this embodiment, the position of the electrode wire 1 along the z-axis might be adjusted, which can significantly simplify a manufacturing process.

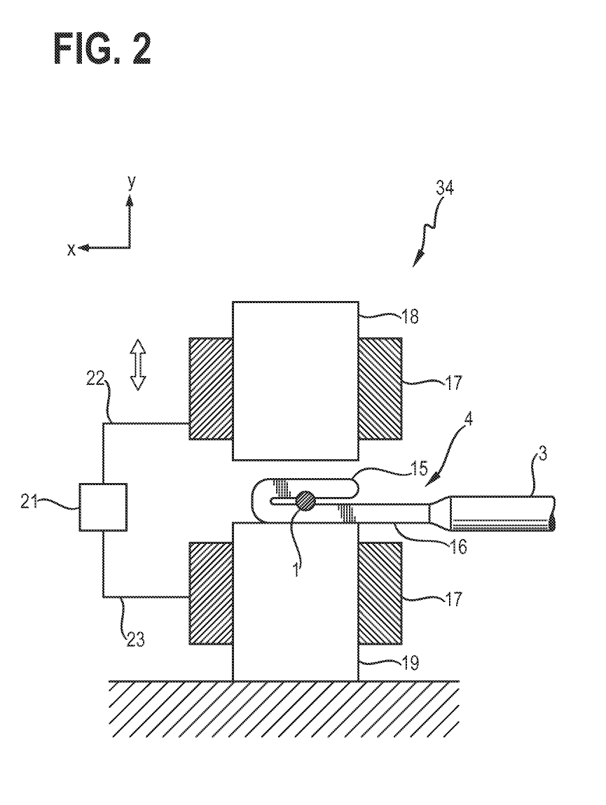

FIG. 2 shows a cross section view of a stamping unit 33 with two stamp dies 18, 19 and a flattened and folded-over end portion 4 of a metallic lead-in wire 3 enclosing a metallic electrode wire 1 according to the invention. Here, the upper stamp die 18 can be moved up- and downwards to achieve the stamping of one or both sections 15, 16 of the folded-over end portion 4 of the lead-in wire 3 which creates the connection to the electrode wire 1. One or both stamp dies 18, 19 might have a profiled surface to hold the lead-in wire 3 and to control the stamping of the lead-in wire 3. Furthermore, two heating cartridges 17 are depicted which heat the stamp dies ahead of or during the stamping step. A control unit 21 provides control signals 22, 23 to control the heating cartridges 17 in order to control the temperature of the stamp dies 18, 19. Temperature sensors, which are not shown here, may be supplied to provide the control unit 21 with temperature data.

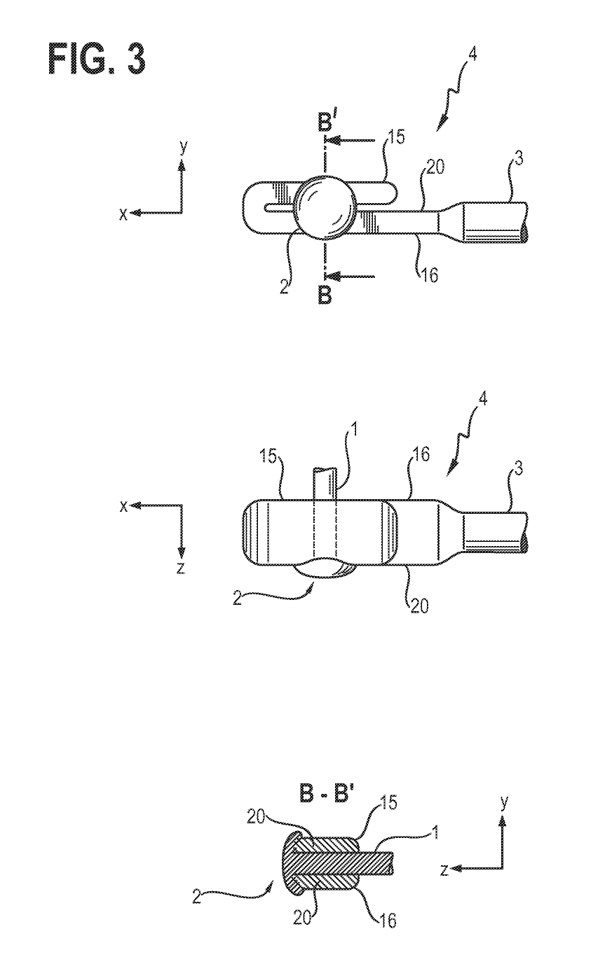

FIG. 3 shows three views of a flattened and folded-over end portion 4 of a metallic lead-in wire 3 enclosing a metallic electrode wire 1 after the end portion 14 of the electrode wire 1 has been molten. The molten region 2 improves the electrical connection to the lead-in wire 3 as compared to FIG. 1. Furthermore, it provides a mechanical fixation along the z-axis. Also, if the molten region 2 is large enough, it can provide a mechanical clamping function, as depicted in the lower part of FIG. 3. The clamp basically prevents, that the folded-over end portion 4 of the lead-in wire 3 opens, thus leading to an additional mechanical fixation along the y-axis.

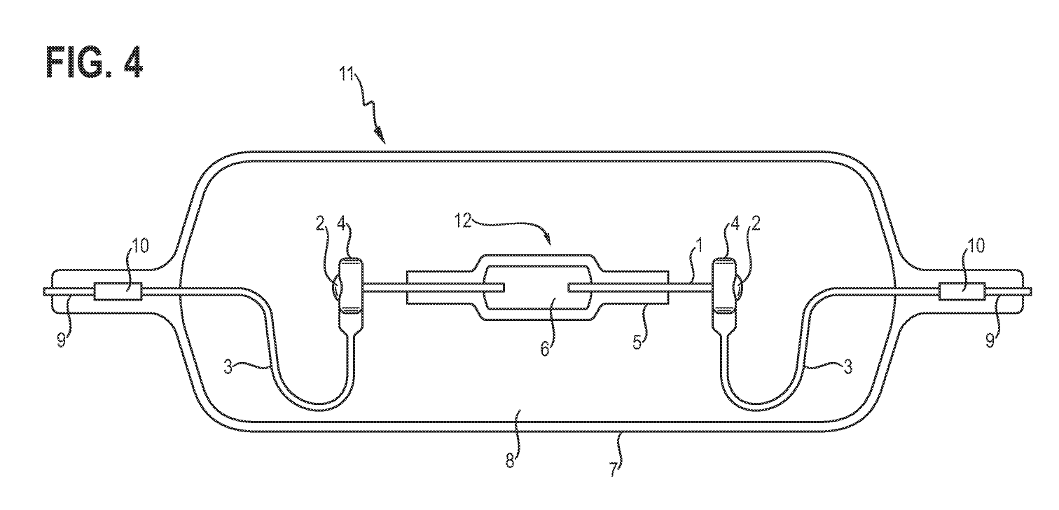

The cross section of an embodiment of a gas discharge lamp 11 that has been manufactured with the methods according to the invention is represented by FIG. 4. An arc tube 12 comprises a discharge vessel 5 which encloses a discharge chamber 6. Two electrode wires 1 are passing from the discharge chamber 6 through the discharge vessel 5 to the outer bulb chamber 8. Each of the electrodes 1 is connected to one lead-in wire 3 at a flattened and folded-over end section 4 and is firmly locked to the lead-in wire 3 by a molten region 2. Molybdenum foils 10 provide the electrical connection through the outer bulb 7 to the outside connectors 9. Here, a welding step to connect the lead-in wire 3 to the molybdenum foil 10 may be used. To seal the outer bulb 7 after this connection has been established, the outer bulb 7 may be heated and compressed locally around each molybdenum foil 10

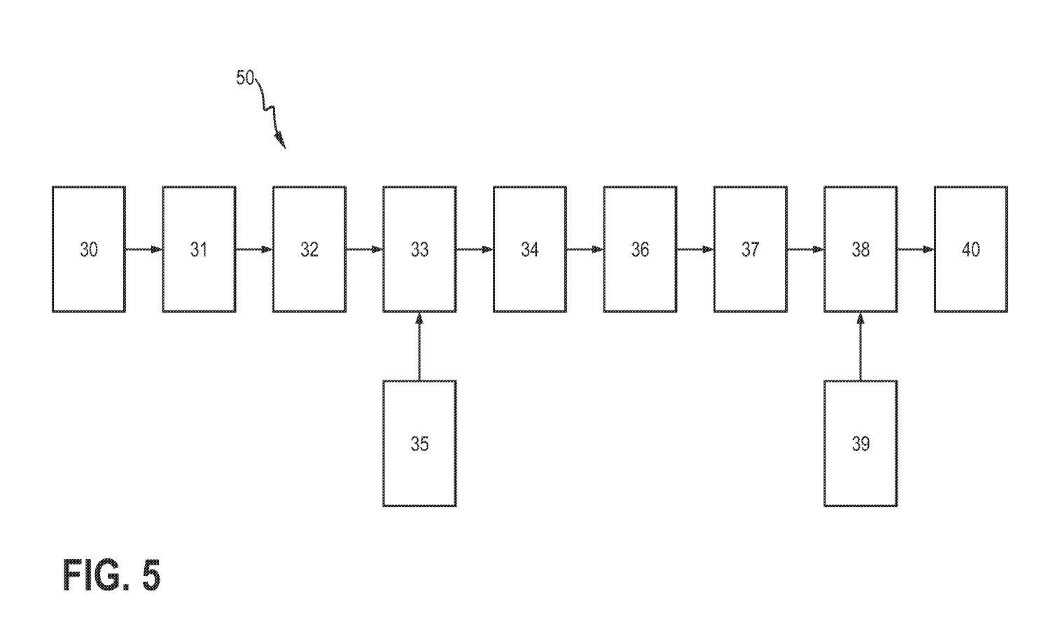

A schematic block diagram of a manufacturing system 50 for gas discharge lamps 11 according to an embodiment of the invention is illustrated in FIG. 5. A lead-in wire unit 30 provides lead-in wires 3 to a flattening unit 31 which flattens an end portion 4 of the lead-in wires 3, preferably while heating the lead-in wires 3 to ensure the mechanical flexibility of the lead-in wires 3, as outlined above. The flattening unit 31 then feeds the flattened lead-in wires 3 to a bending unit 32, which bends and folds over the lead wires 3 according to the previous teachings of the invention. Again, the lead-in wires 3 might be heated during this step to avoid yield and reliability issues. The bending unit 32 supplies the flattened and folded-over lead-in wires 3 to a positioning unit 33 which places the electrode wires 1 of the arc tubes 12 in-between the first section 15 and the second section 16 of the folded-over end portion 14 of the lead-in wires 3. The arc tubes 12 are provided by an arc tube manufacturing unit 35 to the positioning unit 33. The arc tubes 12 with the lead-in wires 3 are transported to a stamping unit 34 which connects the lead-in wires 3 to the electrode wires 1 of the arc tubes 12 as described above by stamping at least parts of the folded-over end portion 4 of the lead-in wires 3 while heating at least a part of the lead-in wires 3 such that the first section 15 and the second section 16 of the folded-over end portion 4 are at least partially touching a portion of the electrode wires 1. In alternative embodiments, the positioning unit 33 may be an integral part of the bending unit 32 or the stamping unit 34, hence the arc tube manufacturing unit 35 would provide the arc tubes 12 to the bending unit 32 or the stamping unit 34, respectively. From the stamping unit 34, the arc tubes 12 with the lead-in wires 3 are fed to a electrode wire heating unit 36 for melting a region 2 of the end portion 14 of the electrode wires 1, in this preferred embodiment a laser fusing unit 36 where at least one laser beam melts the region 2 of the end portion 14 of the electrode wires 1, thereby improving the connection to the lead-in wires 3 as outlined above. Hereby, the electrode wire heating unit 36 might be an integral part of the stamping unit 34. After the melting step, the electrode wire heating unit 36 supplies the arc tubes 12 with the connected lead-in wires 3 to a conditioning unit 37 which conditions the lead-in wires 3, for example by aligning, shortening, or bending them. At this conditioning unit 37, the strain relief 13 of FIG. 4. may be created. The conditioning unit 37 provides the arc tubes 12 with the conditioned lead-in wires 3 to a welding unit 38, which is welding the lead-in wires 3 to molybdenum foils 10, which are supplied by a molybdenum foil unit 39 to the welding unit 38. Finally, the arc tubes 12 with the lead-in wires 3 and the molybdenum foils 10 are fed to an assembly unit 40, which assembles the gas discharge lamps 11, for example by enclosing the parts in translucent outer bulbs 7.

Although the present invention has been disclosed in the form of preferred embodiments and variations thereon, it will be understood that numerous additional modifications and variations could be made thereto without departing from the scope of the invention. For example, even though the invention has been described as a preferred method for gas discharge lamps, it can be easily conceived, that this method might be useful in many other areas where two metallic wires have to be connected in a simple and reliable fashion.

For the sake of clarity, it is also to be understood that the use of “a” or “an” throughout this application does not exclude a plurality, and “comprising” does not exclude other steps or elements. Also, a “unit” may comprise a number of blocks or devices, unless explicitly described as a single entity.

1. A method for manufacturing a conductive connection of a metallic electrode wire (1) and a metallic lead-in wire (3) for a gas discharge lamp (11), preferably a ceramic discharge metal halide lamp, comprising:
bending and folding over an end portion (4) of the lead-in wire (3) such that a first section (15) of the end portion (4) at the tip of the lead-in wire (3) overlaps a second section (16) of the end portion (4), whereby the electrode wire (1) is placed in-between the first section (15) and the second section (16) of the folded-over end portion (4) of the lead-in wire (3);
forming a connection between the electrode wire (1) and the lead-in wire (3) by stamping at least parts of the folded-over end portion (4) of the lead-in wire (3) while heating at least a part of the lead-in wire (3) such that the first section (15) and the second section (16) of the folded-over end portion (4) are at least partially touching a portion of the electrode wire (1).

2. A method according to claim 1, wherein parts of the folded-over end portion (4) of the lead-in wire (3) and of the portion of the electrode wire (1) are deformed during the stamping such that substantially a positive locking of the electrode wire (1) and the lead-in wire (3) is obtained.

3. A method according to claim 1, wherein stamp dies (18, 19) are applied to stamp the at least parts of the folded-over end portion (4) of the lead-in wire (3) and at least one of the stamp dies (18, 19) is heated to heat the lead-in wire (3) during the stamping.

4. A method according to claim 1, wherein the first section (15) and the second section (16) of the end portion (4) of the lead-in wire (3) are aligned substantially in parallel.

5. A method according to claim 1, wherein previous to the bending of the lead-in wire (3), a planar contact area (20) is formed by flattening at least a part of the end portion (4) of the lead-in wire (3).

6. A method according to claim 5, wherein flattening dies are applied to form the planar contact area (20) and at least one of the flattening dies is heated to heat the lead-in wire (3) during the flattening.

7. A method according to claim 1, wherein the method further comprises an alignment of the position of the electrode wire (1) relative to the folded-over end portion (4) of the lead-in wire (3).

8. A method according to claim 1, wherein the lead-in wire (3) is aligned substantially perpendicular to the electrode wire (1).

9. A method according to claim 1, wherein an end portion (14) of the electrode wire (1) is heated after forming the connection such that a region (2) of the end portion (14) of the electrode wire (1) is melting.

10. A method according to claim 9, wherein the molten region (2) of the end portion (14) of the electrode wire (1) is partially touching the folded-over end portion (4) of the lead-in wire (3).

11. A method according to claim 9, wherein a laser beam is pointed towards the end portion (14) of the electrode wire (1) to heat the electrode wire (1).

12. A method for manufacturing a gas discharge lamp (11), preferably a ceramic discharge metal halide lamp, comprising:
providing an arc tube (12) comprising a translucent discharge vessel (5) which is enclosing a discharge chamber (6) filled with an ionizable filling and at least two metallic electrode wires (1) which are partially embedded in the discharge vessel (5), each electrode wire (1) having a first end extending into the discharge chamber (6) and a second end extending to the outside of the discharge vessel (5);
providing metallic lead-in wires (3);
connecting at least one lead-in wire (3) with the second end of an electrode wire (1) by a method according to claim 1;
enclosing the arc tube (12) and the lead-in wires (3) at least partially in a translucent outer bulb (7).

13. A gas discharge lamp (11), preferably a ceramic discharge metal halide lamp, comprising at least one electrically conductive connection of a metallic electrode wire (1) and a metallic lead-in wire (3) for which:
the lead-in wire (3) comprises a folded-over end portion (4) comprising a first section (15) and a second section (16) which are facing each other in a substantially parallel alignment;
the electrode wire (1) is arranged in-between the first section (15) and the second section (16) of the folded-over end portion (4) of the lead-in wire (3) such that the first section (15) and the second section (16) are at least partially touching a portion of the electrode wire (1).

14. The gas discharge lamp (11) of claim 13 wherein the electrode wire (1) comprises an end portion (14) with a molten region (2) which is partially touching the folded-over end portion (4) of the lead-in wire (3).

15. A manufacturing system (50) for gas discharge lamps (11), preferably ceramic discharge metal halide lamps, comprising:
a bending unit (32) for bending and folding over an end portion (4) of a metallic lead-in wire (3) such that a first section (15) of the end portion (4) at the tip of the lead-in wire (3) overlaps a second section (16) of the end portion (4);
a positioning unit (33) for placing a metallic electrode wire (1) of an arc tube (12) in-between the first section (15) and the second section (16) of the folded-over end portion (4) of the lead-in wire (3);
a stamping unit (34) for forming a connection between the electrode wire (1) and the lead-in wire (3) by stamping at least parts of the folded-over end portion (4) of the lead-in wire (3) while heating at least a part of the lead-in wire (3) such that the first section (15) and the second section (16) of the folded-over end portion (4) are at least partially touching a portion of the electrode wire (1).
